(19) United States
(12) Patent Application Publication
(10) Pub. No.: US 2007/0099154 A1
(43) Pub. Date: May 3, 2007

(54) Method of treating dental patients with ultraviolet C range light

(76) Inventor: Robert G. Johnson, Franklinton, NC (US)

Correspondence Address: MYERS BIGEL SIBLEY & SAJOVEC, PO BOX 37428, RALEIGH, NC, 27627, US

(21) Appl. No.: 11/266,452

(22) Filed: Nov. 3, 2005

(51) Int. Cl. A61C 1/00; A61C 5/00

(52) U.S. Cl. 433/215; 433/29

(57) ABSTRACT

A method of treating a dental patient includes applying ultraviolet C radiation to the mouth of the patient for a time and at a proximity and intensity sufficient to have a bacteriocidal effect. With this method, the risk of bacterial infection to both the patient and the dentist/oral surgeon can be reduced.

### FIELD OF THE INVENTION

The present invention relates generally to dental treatments, and more specifically to the prevention of blood borne infectious agents introduced into the body during a dental procedure.

### BACKGROUND OF THE INVENTION

The dental profession is well aware of the possibility of introducing bacteria into a patient's circulatory system while performing normal routine procedures. In routine procedures, such as cleaning a patient's teeth, it is not uncommon to have the gums bleed; bacteria in the mouth can then enter the open wound and infect the patient. The bacteria can then lodge in host organs and replicate itself, resulting in septicemia, endocarditis, and even heart attacks and strokes.

Dental practitioners routinely have the patient swish a germicidal wash in his/her mouth prior to beginning any procedure that can be invasive or result in any blood loss. After the procedure is initiated, generally no proactive procedure is performed to arrest the possibility of infection. During the time the procedure is being performed the patient may be vulnerable to infection by airborne pathogens as well as the recolonization of bacteria from the patient's own mouth. The recolonization may actually be more prolific than the original bacteria colonization, as in open wounds typically the recolonization count is higher than the original.

There may also be a high risk in the dental procedures of cross-contamination from patients. During some procedures, body fluids can spread from the patient's mouth to the face, eyes, nostrils, etc. of the treating professional. Dental instruments often use pressure to dislodge and expel the mouth contents, thus allowing the fluids and bacteria to vaporize and/or become airborne.

It has been known for some time that ultraviolet (UV) light can have antimicrobial effects. See, e.g., Licht, Therapeutic Electricity and Ultraviolet Radiation (Waverly Press, 1967). Early experiments demonstrated that properties of sunlight (either a heating effect or a property of the sun's rays itself) could prevent bacterial growth. Later, UV light was shown to be bacteriocidal to many bacteria, including Mycobacterium tuberculosis, Staphlococcus, Streptococcus, Bacillus anthrasis, and Shigella dysenteriae. UV light has also been a common treatment for tuberculosis of the skin. Id.

UV light can be divided into different classes based on wavelength, including ultraviolet A (UVA) at about 350 nm, ultraviolet B (UVB) at about 300 nm, and ultraviolet C (UVC) at about 250 nm. Not unexpectedly, the effectiveness of UV light in producing biological changes can differ at different wavelengths.

For wound healing, the use of UV light is attractive in that it is a non-pharmalogical treatment that is non-invasive to the wound. It has been demonstrated that UV light can increase epithelial cell turnover, release prostaglandin precursors and histamines, increase vascular permeability, accelerate DNA synthesis, and inactivate bacterial cells. However, UVA and UVB have been shown to cause damage to the skin, particularly in the form of sunburn and blistering, each of which would be undesirable, particularly to an open wound; also, these forms of UV radiation have been demonstrated to be carcinogenic. The use of UVC in the treatment of open wounds is described in U.S. Pat. No. 6,283,986 to Johnson, the disclosure of which is hereby incorporated herein in its entirety.

### SUMMARY OF THE INVENTION

As a first aspect, embodiments of the present invention are directed to a method of treating a dental patient. The method comprises applying ultraviolet C radiation to the mouth of the patient for a time and at a proximity and intensity sufficient to have a bacteriocidal effect. With this method, the risk of bacterial infection to both the patient and the dentist/oral surgeon can be reduced.

As a second aspect, embodiments of the present invention are directed to a dental instrument with bacteriocidal capability. The dental instrument comprises: a handle; a tool portion attached to the handle and configured to be applied to the mouth of a patient; and a UVC lamp mounted on one of the handle and tool portion to illuminate a portion of the patient's mouth during a dental procedure. The dental instrument can be employed during a dental procedure to reduce the risk of bacterial infection.

### BRIEF DESCRIPTION OF THE FIGURES

FIG. 1 is a perspective view of a dental mirror that includes a lamp for illuminating the patient's mouth with UVC radiation according to embodiments of the present invention.

FIG. 2 is a perspective view of a dental drill that includes a lamp for illuminating the patient's mouth with UVC radiation according to embodiments of the present invention.

FIG. 3 is a perspective view of a root canal tool that includes a lamp for illuminating the patient's mouth with UVC radiation according to embodiments of the present invention.

FIG. 4 is a perspective view of a pair of pliers that includes a lamp for illuminating the patient's mouth with UVC radiation according to embodiments of the present invention.

### DETAILED DESCRIPTION OF EMBODIMENTS OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As noted above, the present invention employs UVC radiation in dental treatments. As used herein, “UVC radiation” is intended to encompass ultraviolet radiation having a wavelength of between about 240 and 260 nm. UVC radiation having with a wavelength of between about 243 and 255 nm may be employed in some embodiments; in certain embodiments, a wavelength of between about 245 and 247 nm may be used, as it has been observed that the bacteriocidal effect of the UVC radiation tends to peak at this wavelength range. In other embodiments, a wavelength of between about 253 and 255 nm may be used.

In dental treatments suitable for use with the present invention, UVC radiation may be applied to the mouth of a subject. It is also contemplated that the treatment can be used on both human subjects and non-human subjects (i.e., for veterinary use).

In some embodiments, the UVC radiation may be applied to the mouth with a UVC germicidal lamp, although other UVC radiation sources may also be suitable. A germicidal UVC lamp is generally of the configuration of a fluorescent lamp and operates with the same type of peripheral or auxiliary equipment. A UVC lamp typically contains no phosphor, but has a drop of liquid mercury dispersed in an argon gas vacuum. The mercury floats within the argon; when electricity is introduced, the mercury atoms discharge UVC radiation at approximately 260 nm. The UVC lamp will typically include a special glass bulb, cover or lens that allows transmission of most of the UVC radiation generated by the mercury arc (up to 74 percent of the UVC energy can be transmitted through the glass). A particularly suitable UVC lamp is the V-254 lamp, available from MedFaxx, Inc., Raleigh, N.C.

Because of the varied treatment regimes for different microorganisms, it may be desirable for the UVC radiation source to include components for varying intensity and/or wavelength within the UVC range. Also, an integral timer can be included to time the duration of UVC radiation application. In some embodiments, the UVC radiation may be applied prior to beginning any oral treatment, during a procedure, and/or post-procedure.

The UVC lamp or other UVC radiation source should provide UVC radiation at an intensity that enables it to have a bacteriocidal effect on the microorganism(s) to which it is applied. Typically, an intensity of between about 5 and 20 μW/cm² is suitable, with an intensity of between about 15 and 16 μW/cm² being preferred.

During application of UVC radiation to the mouth of the subject, the UVC lamp or other UVC radiation source should be positioned sufficiently proximate to or within the mouth so as to have a bactericidal effect. This position is typically between about ¼ and 3 inches from the desired treatment area, with a distance of between about ½ and 1 inches being suitable for certain embodiments. This typically positions the lamp inside the subject's mouth. The UVC radiation may be sufficiently diffuse to treat the air inside the patient's mouth during the procedure.

Alternatively, the UVC radiation may be applied to treat particulate matter that is expelled from the mouth and lodges outside the mouth in an area that can be exposed to the radiation.

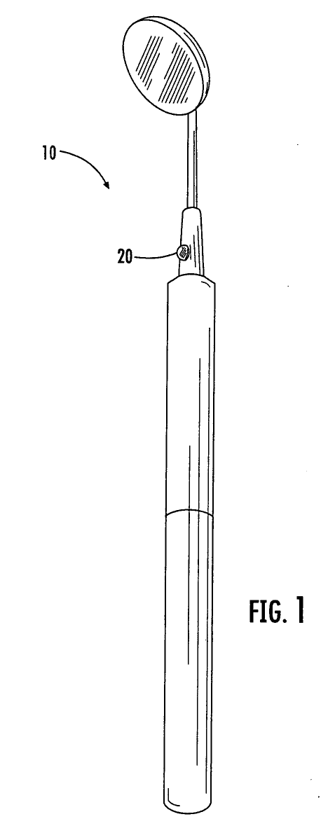

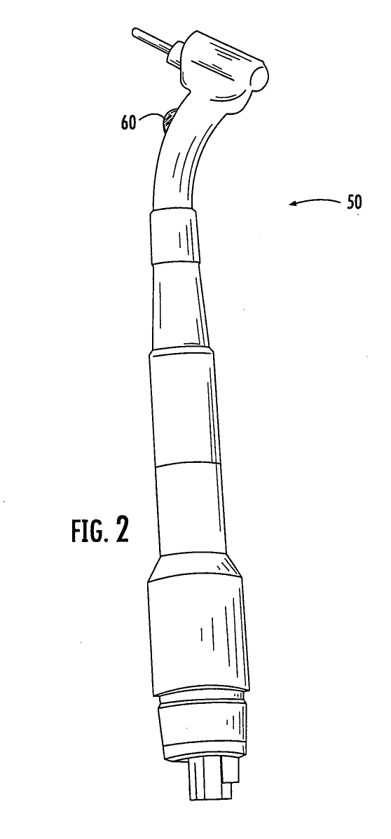

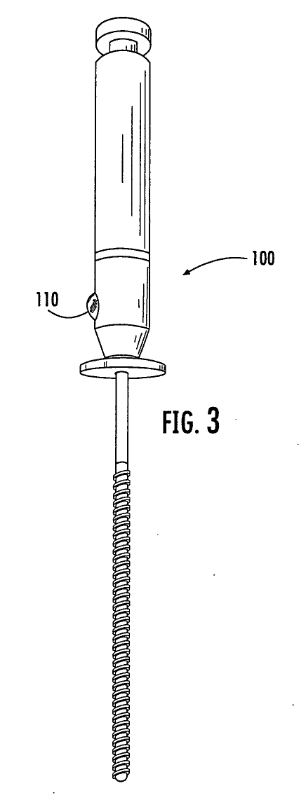

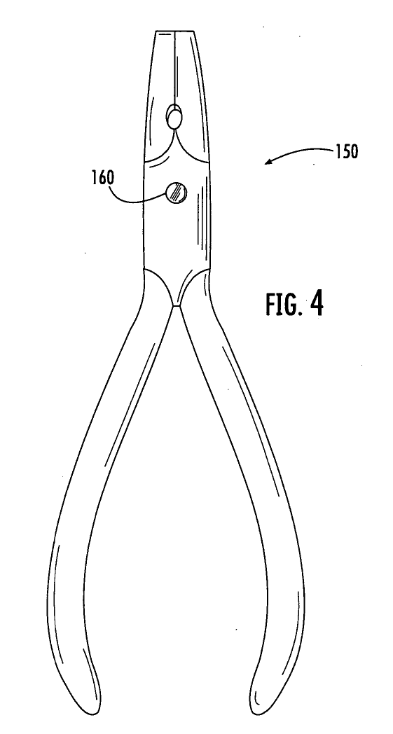

Application of UVC radiation to the patient's mouth may be performed for a time sufficient to have a bacteriocidal effect therein. Typically, the duration of application is between about 5 seconds and 1 minute, with a duration of between about 5 and 30 seconds being preferred. The invention may be a continuous light or may be pulsed at intervals. Of course, the duration may be varied depending on the type and character of the treatment, any specific microorganisms to be eliminated, and the intensity and position of the UVC source. The UVC radiation may be incorporated into instruments presently used by the dental profession, or may be incorporated into a new instrument specific for the dental profession. Such instruments are illustrated in FIGS. 1-4. FIG. 1 shows a dental mirror 10 that includes a lamp 20 for illuminating the patient's mouth with UVC radiation. FIG. 2 shows a dental drill 50 with a lamp 60. FIG. 3 shows a root canal tool 100 with a lamp 110. FIG. 4 shows a pair of pliers 150 with a lamp 160. Those skilled in this art will recognize that other dental instruments, typically comprising a handle and a tool portion attached to the handle for performing a dental procedure, may also include a UVC lamp.

Exemplary dental procedures that may be preceded, followed, or accompanied by application of UVC radiation include tooth scaling, dental implantation, extractions, procedures known to cause mucosal or gingival bleeding, reimplantation of avulsed teeth, root canal surgery, and professional cleaning of high risk patients. High risk patients include, but are not limited to, HIV-positive, diabetic, and hemophiliac patients as well as those with recent hip replacements.

The types of microorganisms that can be treated with the treatment method of the present invention include bacteria, yeast, mold spores, viri, and protozoa. Exemplary lists of microorganisms are set forth in Tables 1-5; those skilled in this art will appreciate that these lists are exemplary only and that other microorganisms may also be suitable for treatment.

TABLE 1

ENERGY
(μW-s/cm²)

| ORGANISM | 90% kill | 100% kill |
|---|---|---|
| Bacillus anthracis | 4520 | 8700 |
| S. enteritidis | 4000 | 7600 |
| B. Megaterium sp. (veg.) | 1300 | 2500 |
| B. Megaterium sp. (spores) | 2730 | 5200 |
| B. paratyphusus | 3200 | 6100 |
| B. subtilis | 5800 | 11000 |
| B. subtilis spores | 11600 | 22000 |
| Clostridium tetani | 13000 | 22000 |
| Corynebacterium diphtheriae | 3370 | 6500 |
| Eberthella typosa | 2140 | 4100 |
| Escherichia coli | 3000 | 6600 |
| Micrococcus candidus | 6050 | 12300 |
| Micrococcus sphaeroides | 10000 | 15400 |
| Myrobacterium tuberculosis | 6200 | 10000 |
| Neisseria catarrhalis | 4400 | 8500 |
| Phtomonas tumeficiens | 4400 | 8500 |
| Proteus vulgaris | 3000 | 6600 |
| Pseudomonas aeruginosa | 5500 | 10500 |
| Pseudomonas fluorescens | 3500 | 6600 |
| S. typhimurium | 8000 | 15200 |
| Salmonella typhosa-typhoid Fever | 2150 | 4100 |
| Salmonella paratyphi-enteric Fever | 3200 | 6100 |
| Sarcina lutea | 19700 | 4200 |
| Serratia marcescens | 2420 | 3400 |
| Shigella dysenteriae-Dysentery | 2200 | 4200 |
| Shigella flexneri-Dysentery | 1700 | 3400 |
| Shigella paradysenteriae | 1680 | 3400 |
| Spirillum rubrum | 4400 | 6160 |
| Staphylococcus albus | 1840 | 5720 |
| Staphylococcus aureus | 2600 | 6600 |
| Streptococcus hemolyticus | 2160 | 5500 |
| Streptococcus lactis | 6150 | 8800 |
| Streptococcus viridans | 2000 | 3800 |
| Vibrio comma-Cholera | 3375 | 6500 |
| Leptospira canicola-Infectious Jaundice | 3150 | 6000 |

*tests carried out at 253.7 nm UVC

TABLE 2

ENERGY
(μW-s/cm²)

| YEAST | 90% kill | 100% kill |
|---|---|---|
| Saccharomyces ellipsoideus | 6000 | 13200 |
| Saccharomyces sp. | 8000 | 17600 |
| Saccharamyces carevisiae | 6000 | 13200 |
| Brewers Yeast | 3300 | 6600 |
| Bakers Yeast | 3900 | 8800 |
| Common yeast cake | 6000 | 13200 |

*tests carried out at 253.7 nm UVC

TABLE 3

| | | ENERGY | |
|---|---|---|---|
| | | (μW-s/cm²) | |
| MOLD SPORES | COLOR | 90% kill | 100% kill |
| Penicillium roqueforti | Green | 13000 | 26400 |
| Penicillium expansum | Olive | 13000 | 22000 |
| Penicillium digitatum | Olive | 44000 | 88000 |
| Aspergillus glaucus | Bluish green | 44000 | 88000 |
| Aspergillus flavus | Yellowish green | 60000 | 99000 |
| Aspergillis niger | Black | 132000 | 330000 |
| Rhisopus nigricans | Black | 111000 | 220000 |
| Mucor racemosus A | White gray | 17000 | 352000 |
| Mucor racemosus B | White gray | 17000 | 352000 |
| Oospora lactis | White | 5000 | 11000 |

*tests carried out at 253.7 nm UVC

TABLE 4

ENERGY
(μW-s/cm²)

| VIRUS | 90% kill | 100% kill |
|---|---|---|
| Bacteriophage (E. Coli) | 2600 | 6600 |
| Infectious Hepatitis | 5800 | 8000 |
| Influenza | 3400 | 6600 |
| Poliovirus-Poliomyelitis | 3150 | 6000 |
| Tobacco mosaic | 240000 | 440000 |

TABLE 5

ENERGY
(μW-s/cm²)

| PROTOZOA | 90% kill | 100% kill |
|---|---|---|
| Paramecium | 110000 | 200000 |
| Nematode eggs | 4000 | 92000 |
| Chlorella vulgaris. | 12000 | 22000 |

*tests carried out at 253.7 nm UVC

It has been observed that different microorganisms may be more susceptible to eradication by different wavelengths within the UVC radiation range. For example, vancomycin-resistant Enterococcus faecalis (VRE) and methicillin-resistant Staphlococcus aureus (MRSA) have both proven to be very susceptible to UVC having a wavelength of 246 nm.

Note that Tables 1-5 also include recommended UVC radiation energy levels to destroy 90 percent and 100 percent of these microorganisms. This information can be used to calculate application duration and frequency. For example, according to Table 3 the mold spore Aspergillis niger requires 330,000 μW-s/cm² for complete destruction. Assuming a UVC output of 2,250 μW per cm² of treatment area, a 146 second application interval is needed for total destruction of the microorganism. This can be accomplished in a single 146 second treatment, or, alternatively, in three 49 second treatments.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention.

That which is claimed is:

1. A method of treating a dental patient, comprising:
applying ultraviolet C radiation to the mouth of the patient for a time and at a proximity and intensity sufficient to have a bacteriocidal effect.

2. The method defined in claim 1, wherein the applying step comprises applying the ultraviolet C radiation to an open wound within the mouth of the patient.

3. The method defined in claim 1, wherein the applying step is carried out prior to, during or after a dental procedure selected from the group consisting of: tooth scaling, dental implantation; extractions; procedures known to cause mucosal or gingival bleeding; reimplantation of avulsed teeth; root canal surgery; and professional cleaning.

4. A dental instrument with bacteriocidal capability, comprising:
a handle;
a tool portion attached to the handle and configured to be applied to the mouth of a patient; and
a UVC lamp mounted on one of the handle and tool portion to illuminate a portion of the patient's mouth during a dental procedure.

5. The dental instrument defined in claim 4, wherein the dental instrument is selected from the group consisting of: mirrors; drills; root canal tools; and pliers.
